(19) United States
(12) Patent Application Publication
(10) Pub. No.: US 2024/0381404 A1
(43) Pub. Date: Nov. 14, 2024

(54) QUALITY OF SERVICE TARGET PERFORMANCE ELEMENT FOR USE IN TRAFFIC FLOW SCHEDULING

(71) Applicant: Cisco Technology, Inc., San Jose, CA (US)

(72) Inventors: Indermeet Singh Gandhi, San Jose, CA (US); Jerome Henry, Pittsboro, NC (US); Robert E. Barton, Richmond (CA); Malcolm Smith, Richardson, TX (US)

(21) Appl. No.: 18/362,371

(22) Filed: Jul. 31, 2023

Related U.S. Application Data
(60) Provisional application No. 63/501,715, filed on May 12, 2023.

(51) Int. Cl. H04W 72/542; H04W 72/1263

(52) U.S. Cl. CPC H04W 72/542; H04W 72/1263

(57) ABSTRACT

A system and method for a quality of service target performance element for use in traffic flow scheduling. In one embodiment, a method includes receiving first information indicating a requested traffic class for an upstream traffic flow, determining one or more target performance characteristics associated with the requested traffic class, and scheduling network resources for the upstream traffic flow based on the one or more target performance characteristics.

### RELATED APPLICATION AND CLAIM TO PRIORITY

This application claims priority to U.S. Provisional Application No. 63/501,715 filed May 12, 2023, and titled “Quality of Service Target Performance Element for Use in Traffic Flow Scheduling,” which is incorporated herein by reference.

### TECHNICAL FIELD

The present disclosure relates generally to a field of wireless communication systems and, more particularly, to a quality of service target performance element for use in traffic flow scheduling.

### BACKGROUND

In wireless communication systems, an access point (AP) may schedule traffic resources for stations (STAs) to transmit uplink communications. Conventional approaches for facilitating such scheduling may involve a STA knowing and communicating the quality of service requirements of an upcoming uplink communication, which may introduce complexities into such approaches.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates an example system for a quality of service target performance element for use in traffic flow scheduling, according to some embodiments of the present disclosure;

FIG. 2 illustrates an example signaling diagram for a quality of service target performance element for use in traffic flow scheduling, according to some embodiments of the present disclosure;

FIG. 3 illustrates an example method for a quality of service target performance element for use in traffic flow scheduling, according to some embodiments of the present disclosure; and

FIG. 4 illustrates an example of a computer system, according to some embodiments of the present disclosure.

### DESCRIPTION OF EXAMPLE EMBODIMENTS

### Overview

Embodiments of this disclosure disclose systems and methods for a quality of service (QoS) target performance element for use in traffic flow scheduling. The proliferation of mobile devices, multimedia applications, and cloud services has led to a significant increase in wireless network traffic. This trend is expected to continue with the deployment of Fifth Generation (5G) networks and the growing adoption of Internet of Things (IoT) devices. However, traditional Wi-Fi QoS mechanisms, such as those defined in the IEEE 802.11e standard, are designed for simple traffic types, such as voice and data, and may not be suitable for complex applications like video streaming, virtual reality, or online gaming. As a result, there is a need for a more sophisticated Wi-Fi QoS management system that can differentiate between different types of traffic and allocate network resources accordingly. The Stream Classification Service (SCS) is a potential solution to this problem. This classification information can be used to map the traffic to a specific QoS class and allocate the appropriate bandwidth and latency resources. Another challenge is the interoperability between 5G and Wi-Fi networks. 5G networks use a different set of QoS parameters, called 5G QoS Parameters (5QI), to manage network traffic. These parameters include latency, throughput, reliability, and priority, among others. However, Wi-Fi networks use different QoS parameters, such as the Access Category (AC) and Transmission Opportunity (TXOP) parameters defined in the IEEE 802.11e standard. This discrepancy can result in inconsistent QoS performance and degradation of user experience when a user switches between 5G and Wi-Fi networks.

To address this issue, a mapping between 5G QoS parameters and Wi-Fi QoS parameters is necessary. This mapping can be achieved through a common QoS framework, such as the IETF DiffServ architecture. Some of the mappings of 5QI to Wi-Fi have been addressed in Wi-Fi QoS Management R2 Specification. However, 5G provides additional metadata in the QoS flows that it sets up with the core network. Such constructs are fundamental because they allow the end describing the flow to provide performance characteristics about the flow, instead of a mere User Priority indicator (which does not help schedule properly). Such mechanism does not exist in 802.11. The systems and methods disclosed herein fill that gap by introducing QoS performance characteristics into the standard. Certain embodiments as described herein provide an augmentation to the 802.11 Standard (in particular the SCS exchange) with information (e.g., an information element) that can qualify the type of performances expected by the upcoming flow. This may simplify the SCS exchange (e.g., by removing the need for the Wi-Fi driver to know the exact packet structure of each application, and removing the need for the application developer to know the details of each possible Wi-Fi driver of the platforms with which the application is expected to be compatible) and allow for a scheduling exchange for applications with simple qualification.

In some embodiments, the techniques described herein relate to a method, including receiving first information indicating a requested traffic class for an upstream traffic flow; determining one or more target performance characteristics associated with the requested traffic class; and scheduling network resources for the upstream traffic flow based on the one or more target performance characteristics.

In some embodiments, the one or more target performance characteristics include parameters associated with one or more of jitter, delay, loss tolerance, and retry rate.

In some embodiments, the method further includes receiving a performance report indicating an observed performance of the upstream traffic flow; comparing the observed performance of the upstream traffic flow to the one or more target performance characteristics; and scheduling a subsequent traffic flow based on one or more differences between the observed performance of the upstream traffic flow and the one or more target performance characteristics.

In some embodiments, the performance report includes one or more of a packet error loss rate, minimum frame delay, maximum frame delay, mean frame delay, and observed maximum burst size associated with the upstream traffic flow.

In some embodiments, the method further includes measuring an observed performance of the upstream traffic flow, comparing the observed performance of the upstream traffic flow to the one or more target performance characteristics, and scheduling a subsequent traffic flow based on one or more differences between the observed performance of the upstream traffic flow and the one or more target performance characteristics.

In some embodiments, the method further includes determining alternative performance characteristics of the upstream traffic flow, transmitting first information indicating an alternative traffic class associated with the alternative performance characteristics, and scheduling the upstream traffic flow based on the alternative performance characteristics.

In some embodiments, the first information is included in a Stream Classification Service request.

In some aspects, the techniques described herein relate to a system, including: one or more processors; and one or more computer-readable non-transitory storage media including instructions that, when executed by the one or more processors, cause one or more components of the system to perform operations including: receiving first information indicating a requested traffic class for an upstream traffic flow; determining one or more target performance characteristics associated with the requested traffic class; and scheduling network resources for the upstream traffic flow based on the one or more target performance characteristics.

In some embodiments, the one or more target performance characteristics include parameters associated with one or more of jitter, delay, loss tolerance, and retry rate.

In some embodiments, the system further includes receiving a performance report indicating an observed performance of the upstream traffic flow, comparing the observed performance of the upstream traffic flow to the one or more target performance characteristics, and scheduling a subsequent traffic flow based on one or more differences between the observed performance of the upstream traffic flow and the one or more target performance characteristics.

In embodiments, the performance report includes one or more of a packet error loss rate, minimum frame delay, maximum frame delay, mean frame delay, and observed maximum burst size associated with the upstream traffic flow.

In some embodiments, the system further includes measuring an observed performance of the upstream traffic flow, comparing the observed performance of the upstream traffic flow to the one or more target performance characteristics, and scheduling a subsequent traffic flow based on one or more differences between the observed performance of the upstream traffic flow and the one or more target performance characteristics.

In some embodiments, the system further includes determining alternative performance characteristics of the upstream traffic flow, transmitting first information indicating an alternative traffic class associated with the alternative performance characteristics, and scheduling the upstream traffic flow based on the alternative performance characteristics.

In some embodiments, the first information is included in a Stream Classification Service request.

In some aspects, the techniques described herein relate to one or more computer-readable non-transitory storage media embodying instructions that, when executed by a processor, cause performance of operations including: receiving first information indicating a requested traffic class for an upstream traffic flow, determining one or more target performance characteristics associated with the requested traffic class, and scheduling network resources for the upstream traffic flow based on the one or more target performance characteristics.

In some embodiments, the one or more target performance characteristics include parameters associated with one or more of jitter, delay, loss tolerance, and retry rate.

In some embodiments, the operations further include: receiving a performance report indicating an observed performance of the upstream traffic flow, comparing the observed performance of the upstream traffic flow to the one or more target performance characteristics, and scheduling a subsequent traffic flow based on one or more differences between the observed performance of the upstream traffic flow and the one or more target performance characteristics.

In some embodiments, the performance report includes one or more of a packet error loss rate, minimum frame delay, maximum frame delay, mean frame delay, and observed maximum burst size associated with the upstream traffic flow.

In some embodiments, the operations further include measuring an observed performance of the upstream traffic flow, comparing the observed performance of the upstream traffic flow to the one or more target performance characteristics, and scheduling a subsequent traffic flow based on one or more differences between the observed performance of the upstream traffic flow and the one or more target performance characteristics.

In some embodiments, the operations further include determining alternative performance characteristics of the upstream traffic flow, transmitting first information indicating an alternative traffic class associated with the alternative performance characteristics, and scheduling the upstream traffic flow based on the alternative performance characteristics.

Technical advantages of certain embodiments of this disclosure may include one or more of the following. A technical advantage of one embodiment may allow for more effective traffic flow scheduling while reducing the complexity required at a station or other client device. A technical advantage of one embodiment may allow for increased performance and improved user experience when a station switches between 5G and Wi-Fi networks. Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

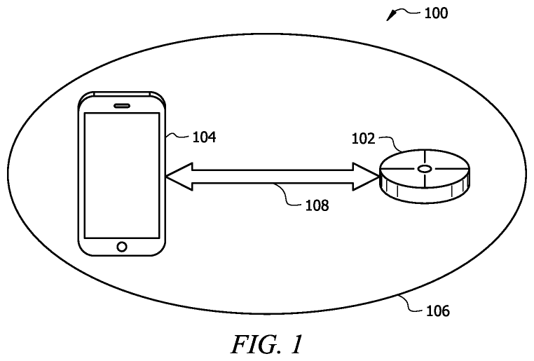

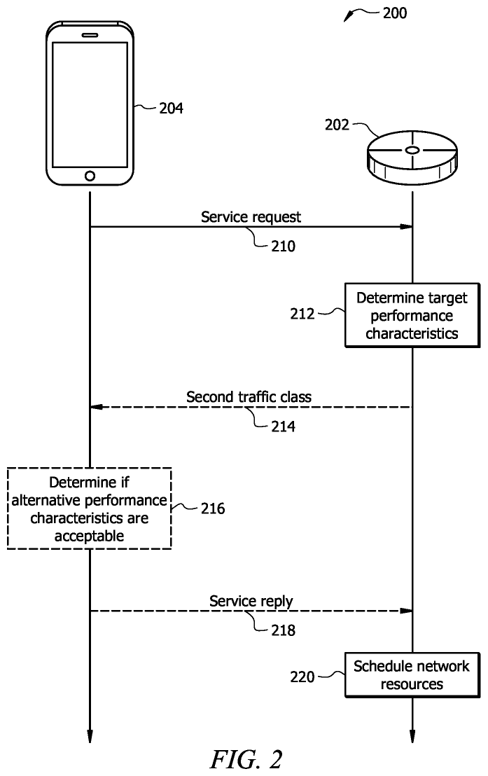

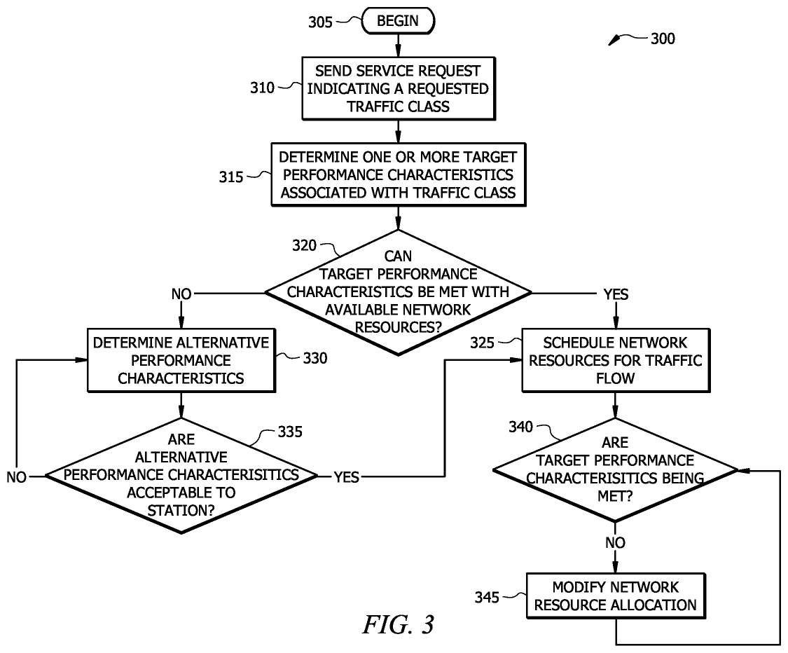

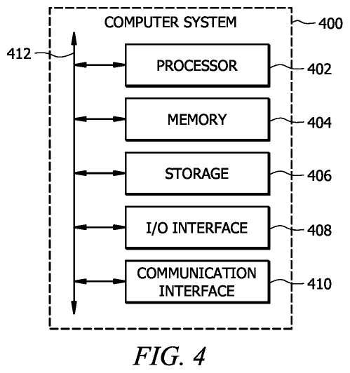

This disclosure describes systems and methods for a quality of service target performance element for use in traffic flow scheduling. FIG. 1 illustrates an example system for a quality of service target performance element for use in traffic flow scheduling, in accordance with certain embodiments. FIG. 2 illustrates an example signaling diagram for a quality of service target performance element for use in traffic flow scheduling, in accordance with certain embodiments. FIG. 3 illustrates an example method for a quality of service target performance element for use in traffic flow scheduling, in accordance with certain embodiments. FIG. 4 illustrates an example of a computer system, in accordance with certain embodiments.

In existing techniques for traffic flow scheduling in a Wi-Fi network, a station (STA) that intends to send scheduled upstream traffic may indicate, in a Stream Classification Service (SCS) request to an access point (AP), basic performance parameters that are sufficient for the AP to perform a scheduling action for the traffic. In one embodiment, the SCS request, which may include a traffic classification (TCLAS) element (e.g., with the 5-tuple source-destination addresses and ports and protocol necessary for the AP to identify the flow) and/or a quality of service (QoS) characteristics (QC) element. The TCLAS element and/or the QC element in the art (e.g., as defined in the IEEE 802.11be D3.0 specification (9.4.2.316)) may require the STA to describe closely 802.11 characteristics of the scheduled upstream traffic, such as the minimum and maximum service intervals, delay bounds, and other information associated with the traffic. In some cases, the STA simply does not have this information, or the information is difficult to determine.

For example, the STA may need to know application-level requirements of the scheduled uplink traffic flow, as well as characteristics of the Wi-Fi stack so that the application-level requirements can be translated into 802.11 parameters. Further, such mapping may not be static, as some applications may change coder/decoders (codecs) if the STAs on which the applications run change orientations (e.g., is rotated from portrait to landscape), if the STAs experience changing Wi-Fi conditions, or if the STAs vary in computational power (e.g., as a result of the applications being able to run on various STAs with different processing power), all of which may require unique SCS request determinations based on an STA's configuration or conditions. Such operation is complex for STAs that do not know relevant application-level requirements in specific detail, and may be particularly difficult for non-specialized STAs. Further, such operation may require an application developer to know the relevant application-level requirements for each platform or Wi-Fi driver with which their application may be compatible, which adds increasing complexity to traditional SCS operation. Similarly, complexities arise when a STA moves between a 5G network and a Wi-Fi network, since both networks use different schemes for characterizing QoS requirements. Moving between 5G and Wi-Fi networks therefore requires STAs to have appropriate mappings readily available, which may not be feasible for devices that do not have access to cellular technologies (e.g., some laptops or other Wi-Fi-only devices).

Certain embodiments as described herein improve on these conventional approaches by introducing new information (e.g., a new information element that may be included in a SCS request) sent from a STA to an AP that indicates high-level target performance characteristics for an upcoming traffic flow. These performance characteristics may be indicated by a class (e.g., represented by an integer) that is associated with the target performance characteristics of the upcoming traffic flow. By associating the indicated class with the target performance characteristics, the AP may be able to schedule resources for the upcoming traffic flow to meet the target performance characteristics. The new information (e.g., information element) may simplify the SCS exchange by removing the need for the STA to know the particular packet structure for each application associated with a traffic flow, as well as removing the need for application developers to know the particular details of each Wi-Fi driver with which the application is expected to be compatible. It would also allow a simplified technique for qualifying application traffic flows and the scheduling thereof.

FIG. 1 is an illustration of an example system for a quality of service target performance element for use in traffic flow scheduling, in accordance with certain embodiments. The components of system 100 may include any suitable combination of hardware, firmware, and software. For example, the components of system 100 may use one or more elements of the computer system of FIG. 4. In the illustrated embodiment, system 100 may include a network implementing at least one of the IEEE 802.11 family of standards (such as that defined by the IEEE 802.11-2016 specification or amendments thereof including, but not limited to, 802.11ah, 802.11ad, 802.11ay, 802.11ax, 802.11az, 802.11ba, and 802.11be). System 100 may include numerous wireless communication devices such as access points (APs) 102 and stations (STAs) 104. While only one STA 104 is shown, system 100 also may include multiple STAs 104.

STA 104 also may be referred to as a mobile station (MS), a mobile device, a mobile handset, a wireless handset, an access terminal (AT), a user equipment (UE), a subscriber station (SS), or a subscriber unit, among other possibilities. STA 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated STA 104 (or set of STAs 104) may be referred to as a basic service set (BSS), which is managed by the respective AP 102. FIG. 1 additionally shows an example coverage area 106 of the AP 102, which may represent a basic service area (BSA) of system 100. The BSS may be identified to users by a service set identifier (SSID), as well as to other devices by a basic service set identifier (BSSID), which may be a medium access control (MAC) address of the AP 102. AP 102 may periodically broadcast beacon frames (“beacons”) including the BSSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons may include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, STA 104 may be configured to perform passive or active scanning operations (“scans”) on frequency channels in one or more frequency bands (for example, the 2.4 GHz, 5.0 GHz, 6.0 GHz, or 60 GHz bands). To perform passive scanning, STA 104 may listen for beacons, which may be transmitted by respective APs 102 at a periodic time interval referred to as the target beacon transmission time (TBTT) (measured in time units (TUs) where one TU may be equal to 1024 microseconds (s)). To perform active scanning, STA 104 may generate and sequentially transmit probe requests on each channel to be scanned and then listen for probe responses from APs 102. STA 104 may be configured to identify or select an AP 102 with which to associate based on the scanning information obtained through the passive or active scans, and to perform authentication and association operations to establish a communication link 108 with the selected AP 102. The AP 102 may assign an association identifier (AID) to the STA 104 at the culmination of the association operations, which the AP 102 may use to track the STA 104. For example, AP 102 and STA 104 may communicate via communication link 108.

AP 102 and STA 104 may function and communicate (via communication link 108) according to the IEEE 802.11 family of standards (such as that defined by the IEEE 802.11-2016 specification or amendments thereof including, but not limited to, 802.11ah, 802.11ad, 802.11ay, 802.11ax, 802.11az, 802.11ba, and 802.11be). These standards define the WLAN radio and base band protocols for the physical (PHY) and medium access control (MAC) layers. AP 102 and STA 104 may transmit and receive wireless communications (hereinafter also referred to as “Wi-Fi communications”) to and from one another in the form of physical layer convergence protocol (PLCP) protocol data units (PPDUs). AP 102 may represent any device that schedules network resources used for wireless communications between AP 102 and STA 104. For example, AP 102 may allocate a certain number of transmission frames per second for STA 104 to use for an upstream traffic flow.

In some embodiments, STA 104 may have an upcoming upstream traffic flow associated with a particular application running on STA 104. For example, STA 104 may run a first application that streams video from STA 104. Accordingly, STA 104 may generate an SCS request (or other purpose-built management frame) and send the SCS request to AP 102 via communication link 108. The SCS request may include a QoS target performance element that indicates a traffic class associated with the target performance characteristics for the upstream traffic flow. The traffic class may be represented as a simple code, such as an integer, and may be included in the SCS request in a QoS target performance element. A traffic class may be associated with a set of one or more performance characteristics, such as jitter, delay, loss tolerance, and retry rate such that each traffic class corresponds to a unique set of performance characteristics. For example, a first traffic class may be associated with low loss tolerance (e.g., packet loss below a first threshold), and a second traffic class may be associated with low delay (e.g., delay below a second threshold) and medium loss tolerance (e.g., packet loss between a third threshold and a fourth threshold). Accordingly, by indicating a particular traffic class in the QoS target performance element of the SCS request, STA 104 may indicate to AP 102 the target performance characteristics the STA 104 wants to achieve for the associated upcoming upstream traffic flow. The association between a traffic class and performance characteristics may be standardized (e.g., in an IEEE 802.11 specification) such that STA 104 and AP 102 understand how a traffic class corresponds to particular performance characteristics without having to coordinate this understanding.

Upon receiving the SCS request from STA 104, AP 102 may determine the traffic class indicated in the QoS target performance element of the SCS request. AP 102 may then determine the performance characteristics associated with the traffic class. Upon determining the associated performance characteristics, AP 102 may schedule network resources for the upstream traffic flow based on the associated performance characteristics. For example, the traffic class indicated in the QoS target performance element of the SCS request may identify a first traffic class, which AP 102 may determine is associated with low loss tolerance (e.g., packet loss below a first threshold). Accordingly, AP 102 may determine that the upcoming upstream traffic flow from STA 104 should be allotted sufficient network resources to facilitate the upstream traffic flow's adherence to the requested target performance characteristics (i.e., the performance characteristics associated with the traffic class indicated in the QoS target performance element of the SCS request). Thus, AP 102 may reserve a certain number of frames per second, or allocate certain bandwidth and/or latency resources, for STA 104's transmission of the upstream traffic flow.

FIG. 2 is an illustration of a signaling diagram 200 for a quality of service target performance element for use in traffic flow scheduling, according to particular embodiments. The components shown in FIG. 2 may include any suitable combination of hardware, firmware, and software. For example, the components shown in FIG. 2 may use one or more elements of the computer system of FIG. 4. AP 202 and STA 204 may be associated with each other and may exchange one or more messages as shown in FIG. 2. AP 202 may correspond to AP 102 described above with reference to FIG. 1. STA 204 may correspond to STA 104 as described above with reference to FIG. 1.

As discussed above with reference to FIG. 1, STA 204 may transmit service request 210 to AP 202. Service request 210 may include a QoS target performance element, which may indicate a requested traffic class associated with an upcoming upstream traffic flow from STA 204. Service request 210 may be an SCS request, for example.

Upon receiving service request 210, AP 202, at step 212, may determine target performance characteristics associated with the requested traffic class, as discussed in more detail above with reference to FIG. 1. In some embodiments, AP 202 may determine that it cannot schedule resources sufficient for the upstream traffic flow from STA 204 to meet the associated target performance characteristics (e.g., due to resource constraints or policy configurations). For example, the associated target performance characteristics as requested by STA 204 may require certain bandwidth or latency resources that are not available. Accordingly, AP 202 may determine a set of alternative performance characteristics that may be supported by available network resources. AP 202 may then determine an alternative traffic class associated with the set of alternative performance characteristics, and, in message 214, send the alternative traffic class to STA 204.

At step 216, STA 204 may receive message 214 and determine the alternative traffic class. STA 204 may then determine the set of alternative performance characteristics associated with the alternative traffic class and whether the set of alternative performance characteristics are suitable for the upcoming upstream traffic flow. For example, STA 204 may determine that the alternative performance characteristics offer lower performance values than those originally requested by STA 204 (i.e., in service request 210) but are still suitable for the upcoming upstream traffic flow. Accordingly, STA 204 may transmit service reply 218 to indicate that the alternative performance characteristics are suitable to STA 204.

If STA 204 determines that the alternative performance characteristics are not suitable to STA 204, STA 204 may include the originally-requested traffic class (i.e., the traffic class included in service request 210) in service reply 218, to indicate to AP 202 that STA 204 prefers (or needs) the original target performance characteristics (i.e., the target performance characteristics associated with the traffic class included in service request 210). In some embodiments, if STA 204 determines that the alternative performance characteristics are not suitable to STA 204, STA 204 may include a third traffic class in service reply 218, which may indicate that STA 204 is requesting a third set of target performance characteristics for the upcoming upstream traffic flow.

In some embodiments, STA 204 may determine that some but not all of the alternative performance characteristics are suitable to STA 204 while the other alternative performance characteristics are not suitable to STA 204. In such cases, STA 204 may indicate, in service reply 218, which alternative performance characteristics are suitable to STA 204 and which alternative performance characteristics are not suitable to STA 204. And STA 204 may also suggest, in service reply 218, replacement values for the alternative performance characteristics that are not suitable to STA 204.

AP 202 and STA 204 may continue this process of negotiating target performance characteristics until a suitable set of target performance characteristics is agreed upon by AP 202 and STA 204. At such a point, STA 204, at step 220, may schedule network resources sufficient for the upstream traffic flow from STA 204 to meet the agreed-upon target performance characteristics, as discussed in more detail above with reference to FIG. 1.

FIG. 3 illustrates an example method for a quality of service target performance element for use in traffic flow scheduling, according to some embodiments of the present disclosure. Method 300 begins at step 305. At step 310, STA 104 may transmit a service request (e.g., an SCS request) to AP 102 that indicates a requested traffic class associated with an upcoming upstream traffic flow from STA 104. The requested traffic class may be included as an integer in a QoS target performance element in the service request. As discussed above with reference to FIGS. 1 and 2, the requested traffic class may be associated with a set of target performance characteristics (i.e., one or more of jitter, loss tolerance, delay, and retry rate) that STA 104 would like to achieve for the upstream traffic flow. Upon receiving the service request, AP 102 may, at step 315, determine the target performance characteristics associated with the requested traffic class.

At step 320, AP 102 may determine whether the network resources (e.g., bandwidth and latency resources) needed to meet the target performance characteristics are available. For example, AP 102 may determine whether it can allocate a number of frames per second necessary to meet the target performance characteristics requested by STA 104. If AP 102 determines that the requisite resources are available, AP 102 may schedule the network resources for the upstream traffic flow (at step 325) and may indicate this scheduling to STA 104.

If AP 102 determines that the requisite resources are not available, then, at step 330, AP 102 may determine a set of alternative performance characteristics that can be met by the available network resources. AP 102 may then determine an alternative traffic class associated with the alternative performance characteristics and transmit a message to STA 104 indicating the alternative traffic class. At step 335, STA 104 may determine if the alternative performance characteristics are acceptable for the upstream traffic flow. If the alternative performance characteristics are not acceptable, STA 104 may, in another service request, identify a third traffic class associated with new performance characteristics (or may simply modify one or more of the alternative performance characteristics). As discussed with reference to FIG. 2, steps 330 and 335 may be repeated until STA 104 and AP 102 agree on a suitable set of performance characteristics for the upstream traffic flow.

At step 325, upon AP 102 and STA 104 agreeing on a suitable set of performance characteristics for the upstream traffic flow, or if AP 102 determines that the originally-requested target performance characteristics (i.e., those associated with the traffic class requested in step 310) may be supported by available network resources, AP 102 may schedule the network resources necessary to support the agreed-upon performance characteristics or the originally-requested target performance characteristics (i.e., the “target performance characteristics”). For example, AP 102 may allocate a certain number of frames per second for the upstream traffic flow, or AP 102 may allocate certain bandwidth and/or latency resources for the upstream traffic flow. STA 104 may then use the scheduled network resources to transmit the upstream traffic flow.

At step 340, STA 104 and/or AP 102 may periodically (e.g., at certain intervals) check on whether the target performance characteristics are being met. For example, STA 104 may measure performance characteristics of the upstream traffic flow and may send to AP 102 a performance report element (PRE) in an action frame or some other message. A PRE may include, for example, an SCS flow identifier associated with the upstream traffic flow, the associated QoS target performance element value (i.e., the originally-request or agreed-upon traffic class, as described in more detail with respect to FIGS. 1 and 2), and the performance characteristics observed by STA 104 over a corresponding interval (e.g., as configured by AP 102 or STA 104). For example, the reported performance characteristics may include a minimum frame delay (e.g., as indicated by the time period between a frame's insertion into STA 104's buffer and STA 104 successfully transmitting the frame to AP 102), a maximum frame delay, a mean frame delay, a packet error loss rate, a priority value (e.g., which may be used to arbitrate priority between two traffic flows), and/or an observed maximum burst size (e.g., as indicated by a maximum number of frames in STA 104's buffer). STA 104 may generate and transmit a PRE without solicitation, or STA 104 may generate and transmit a PRE in response to AP 102 polling STA 104 for a PRE. In some cases, STA 104 may transmit a PRE to AP 102 based on determining that the measured performance characteristics of the upstream traffic flow are not meeting the target performance characteristics.

Upon receiving a PRE from STA 104, AP 102 may use the PRE to compare the observed performances to the target performance characteristics (i.e., the agreed-upon target performance characteristics or the originally-requested target performance characteristics). If AP 102 determines that the observed performance characteristics deviate from the target performance characteristics (e.g., below or above a threshold), AP 102, at step 345, may modify its scheduling scheme to STA 104 accordingly. For example, if AP 102 determines that the observed performance characteristics of the upstream traffic flow fall below one or more of the target performance characteristics, AP 102 may, for example, allocate larger resources units (RUs) for the upstream traffic flow (e.g., if AP 102 determines that the observed maximum burst size is larger than an allocated RU allows), or AP 102 may allocate more slots for the upstream traffic flow (e.g., if the observed loss rate is above a target loss rate). Similarly, AP 102 may make its own measurements for the upstream traffic flow and determine to modify its scheduling scheme to STA 104 upon determining that the observed performance characteristics deviate from the target performance characteristics.

If AP 102 determines to modify its scheduling scheme based on the observed performance characteristics of the upstream traffic flow, steps 340 and 345 may be repeated such that STA 104 and/or AP 102 continue to monitor the performance characteristics of the upstream traffic flow such that AP 102 may modify its scheduling scheme in accordance with any deviations between the observed performance characteristics and the target performance characteristics.

In some cases, STA 104 may not know (e.g., may not be configured by an application developer) the QoS target performance for a given traffic flow and therefore may be unable to identify a traffic class in a QoS target performance element. In such a case, STA 104 may include in an SCS request a TCLAS (traffic classification) element that identifies the application that will be sending the upstream traffic flow and include in the QoS target performance element a wildcard value (i.e., a value that is not associated with a particular set of target performance characteristics, or a value that is associated with a null set of target performance characteristics). Upon receiving the SCS request from STA 104, AP 102 may use a flow database to characterize the flow (i.e., determine a set of target performance characteristics and associated traffic class) associated with the applicating identified by the TCLAS element, if it is known. AP 102 may then return in a responsive SCS response the determined traffic class, thereby suggesting a set of target performance characteristics to STA 104. In another embodiment, AP 102 may determine a set of performance characteristics and indicate the determined performance characteristics in a downstream PRE.

In another embodiment, AP 102 may not know the flow identified by the TCLAS element and may therefore be unable to characterize the flow. AP 102 may then indicate this lack of knowledge (e.g., with a flag) in a response to STA 104's SCS request and offer a default (or mean) starting traffic class and associated scheduling scheme. STA 104 may start the upstream traffic flow according to the associated scheduling scheme, at which point STA 104 and/or AP 102 may begin monitoring the performance characteristics of the traffic flow and modifying the scheduling scheme for the upstream traffic flow, as described above with respect to steps 340 and 345. Accordingly, AP 102 may be able to a develop a profile for the identified traffic flow (i.e., determine a set of default performance characteristics for the identified traffic flow) such that AP 102 may be able to more accurately characterize the traffic flow or similar traffic flows in the future.

Although this disclosure describes and illustrates particular steps of method 300 of FIG. 3 as occurring in a particular order, this disclosure contemplates any suitable steps of method 300 of FIG. 3 occurring in any suitable order. Although this disclosure describes and illustrates an example method for a quality of service target performance element for use in traffic flow scheduling, including the particular steps of method 300 of FIG. 3, this disclosure contemplates any suitable method for a quality of service target performance element for use in traffic flow scheduling, including any suitable steps, which may include all, some, or none of the steps of method 300 of FIG. 3, where appropriate. Although FIG. 3 describes and illustrates particular components, devices, or systems carrying out particular actions, this disclosure contemplates any suitable combination of any suitable components, devices, or systems carrying out any suitable actions.

FIG. 4 illustrates an example of a computer system, in accordance with certain embodiments. In particular embodiments, one or more computer systems 400 provide functionality described or illustrated herein. As an example, one or more computer systems 400 may be used to provide at least a portion of AP 102 or STA 104 described with respect to FIG. 1. As yet another example, one or more computer systems 400 may be used to perform one or more steps described with respect to FIG. 2 and FIG. 3. In particular embodiments, software running on one or more computer systems 400 provides functionality described or illustrated herein or performs one or more steps of one or more methods described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example, and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein.

Modifications, additions, or omissions may be made to the elements shown in the figure above. The components of a device may be integrated or separated. Moreover, the functionality of a device may be performed by more, fewer, or other components. The components within a device may be communicatively coupled in any suitable manner. Functionality described herein may be performed by one device or distributed across multiple devices. In general, systems and/or components described in this disclosure as performing certain functionality may comprise non-transitory computer readable memory storing instructions and processing circuitry operable to execute the instructions to cause the system/component to perform the described functionality.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry configured to execute program code stored in memory. The term unit may have conventional meaning in the field of electronics, electrical devices and/or electronic devices and may include, for example, electrical and/or electronic circuitry, devices, modules, processors, receivers, transmitters, memories, logic solid state and/or discrete devices, computer programs or instructions for carrying out respective tasks, procedures, computations, outputs, and/or displaying functions, and so on, as such as those that are described herein.

What is claimed is:

1. A method, comprising:
receiving first information indicating a requested traffic class for an upstream traffic flow;
determining one or more target performance characteristics associated with the requested traffic class; and
scheduling network resources for the upstream traffic flow based on the one or more target performance characteristics.

2. The method of claim 1, wherein the one or more target performance characteristics comprise parameters associated with one or more of jitter, delay, loss tolerance, and retry rate.

3. The method of claim 1, further comprising:
receiving a performance report indicating an observed performance of the upstream traffic flow;
comparing the observed performance of the upstream traffic flow to the one or more target performance characteristics; and
scheduling a subsequent traffic flow based on one or more differences between the observed performance of the upstream traffic flow and the one or more target performance characteristics.

4. The method of claim 3, wherein the performance report comprises one or more of a packet error loss rate, minimum frame delay, maximum frame delay, mean frame delay, and observed maximum burst size associated with the upstream traffic flow.

5. The method of claim 1, further comprising:
measuring an observed performance of the upstream traffic flow;
comparing the observed performance of the upstream traffic flow to the one or more target performance characteristics; and
scheduling a subsequent traffic flow based on one or more differences between the observed performance of the upstream traffic flow and the one or more target performance characteristics.

6. The method of claim 1, further comprising:
determining alternative performance characteristics of the upstream traffic flow;
transmitting first information indicating an alternative traffic class associated with the alternative performance characteristics; and
scheduling the upstream traffic flow based on the alternative performance characteristics.

7. The method of claim 1, wherein the first information is included in a Stream Classification Service request.

8. A system, comprising:
one or more processors; and
one or more computer-readable non-transitory storage media comprising instructions that, when executed by the one or more processors, cause one or more components of the system to perform operations comprising:
receiving first information indicating a requested traffic class for an upstream traffic flow;
determining one or more target performance characteristics associated with the requested traffic class; and
scheduling network resources for the upstream traffic flow based on the one or more target performance characteristics.

9. The system of claim 8, wherein the one or more target performance characteristics comprise parameters associated with one or more of jitter, delay, loss tolerance, and retry rate.

10. The system of claim 8, further comprising:
receiving a performance report indicating an observed performance of the upstream traffic flow;
comparing the observed performance of the upstream traffic flow to the one or more target performance characteristics; and
scheduling a subsequent traffic flow based on one or more differences between the observed performance of the upstream traffic flow and the one or more target performance characteristics.

11. The system of claim 10, wherein the performance report comprises one or more of a packet error loss rate, minimum frame delay, maximum frame delay, mean frame delay, and observed maximum burst size associated with the upstream traffic flow.

12. The system of claim 8, further comprising:
measuring an observed performance of the upstream traffic flow;
comparing the observed performance of the upstream traffic flow to the one or more target performance characteristics; and
scheduling a subsequent traffic flow based on one or more differences between the observed performance of the upstream traffic flow and the one or more target performance characteristics.

13. The system of claim 8, further comprising:
determining alternative performance characteristics of the upstream traffic flow;
transmitting first information indicating an alternative traffic class associated with the alternative performance characteristics; and
scheduling the upstream traffic flow based on the alternative performance characteristics.

14. The system of claim 8, wherein the first information is included in a Stream Classification Service request.

15. One or more computer-readable non-transitory storage media embodying instructions that, when executed by a processor, cause performance of operations comprising:
receiving first information indicating a requested traffic class for an upstream traffic flow;
determining one or more target performance characteristics associated with the requested traffic class; and
scheduling network resources for the upstream traffic flow based on the one or more target performance characteristics.

16. The one or more computer-readable non-transitory storage media of claim 15, wherein the one or more target performance characteristics comprise parameters associated with one or more of jitter, delay, loss tolerance, and retry rate.

17. The one or more computer-readable non-transitory storage media of claim 15, the operations further comprising:
receiving a performance report indicating an observed performance of the upstream traffic flow;
comparing the observed performance of the upstream traffic flow to the one or more target performance characteristics; and
scheduling a subsequent traffic flow based on one or more differences between the observed performance of the upstream traffic flow and the one or more target performance characteristics.

18. The one or more computer-readable non-transitory storage media of claim 17, wherein the performance report comprises one or more of a packet error loss rate, minimum frame delay, maximum frame delay, mean frame delay, and observed maximum burst size associated with the upstream traffic flow.

19. The one or more computer-readable non-transitory storage media of claim 15, the operations further comprising:
measuring an observed performance of the upstream traffic flow;
comparing the observed performance of the upstream traffic flow to the one or more target performance characteristics; and
scheduling a subsequent traffic flow based on one or more differences between the observed performance of the upstream traffic flow and the one or more target performance characteristics.

20. The one or more computer-readable non-transitory storage media of claim 15, the operations further comprising:
determining alternative performance characteristics of the upstream traffic flow;
transmitting first information indicating an alternative traffic class associated with the alternative performance characteristics; and
scheduling the upstream traffic flow based on the alternative performance characteristics.
